(19) United States
(12) Patent Application Publication
(10) Pub. No.: US 2015/0199108 A1
(43) Pub. Date: Jul. 16, 2015

(54) CHANGING USER INTERFACE ELEMENT BASED ON INTERACTION THEREWITH

(71) Applicant: Lenovo (Singapore) Pte. Ltd., New Tech Park (SG)

(72) Inventor: Xin Feng, Arcadia, CA (US)

(73) Assignee: Lenovo (Singapore) Pte. Ltd., New Tech Park (SG)

(21) Appl. No.: 14/156,864

(22) Filed: Jan. 16, 2014

(51) Int. Cl. G06F 3/0481; G06F 3/0482

(52) U.S. Cl. CPC G06F 3/04817; G06F 3/0482

(57) ABSTRACT

In one aspect, an apparatus includes a processor and a memory accessible to the processor. The memory bears instructions executable by the processor to determine a weight for an application based on user interaction therewith, and establish how much of an area between a shortcut icon and a second icon is allocated to the application based at least in part on the weight.

### I. FIELD

The present application relates generally to changing user interface (UI) elements based on a weight of the underlying applications and/or interaction therewith.

### II. BACKGROUND

When an application on a computer is created, thereafter a shortcut may be provided to the application in the form of a selectable input element, often referred to as a “tile,” on the screen. But all tiles typically have the same size regardless of how important the user finds the underlying applications.

### SUMMARY

Accordingly, in a first aspect an apparatus includes a processor and a memory accessible to the processor. The memory bears instructions executable by the processor to determine a weight for an application based on user interaction therewith, and establish how much of an area between a shortcut icon and a second icon is allocated to the application based at least in part on the weight. The shortcut icon is selectable to invoke the application.

In another aspect, an apparatus includes a processor and a memory accessible to the processor. The memory bears instructions executable by the processor to determine a weight of an application based on user interaction therewith, and alter a parameter related to a shortcut icon selectable to invoke the application based at least in part on the weight.

In still another aspect, a method includes determining a weight of an application based on user interaction therewith and altering a parameter related to a shortcut icon selectable to invoke the application based at least in part on the weight.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an exemplary device in accordance with present principles;

FIG. 2 is a block diagram of a network of devices in accordance with present principles;

FIGS. 3-6 are flow charts showing example logic for re-sizing shortcut icons based on importance;

FIGS. 7 and 8 are example screenshots illustrating an outcome of the logic of FIGS. 3-6;

FIG. 9 is a flow chart for establishing border area allocation between adjacent icons based on importance;

FIG. 10 is an example screenshot showing a user touching a border area between icons; and

FIGS. 11 and 12 are schematic representations of changing border allocation between icons.

### DETAILED DESCRIPTION

This disclosure relates generally to (e.g. consumer electronics (CE)) device based user information. With respect to any computer systems discussed herein, a system may include server and client components, connected over a network such that data may be exchanged between the client and server components. The client components may include one or more computing devices including televisions (e.g. smart TVs, Internet-enabled TVs), computers such as laptops and tablet computers, and other mobile devices including smart phones. These client devices may employ, as non-limiting examples, operating systems from Apple, Google, or Microsoft. A Unix operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g. that may not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term“circuit” or“circuitry” is used in the summary, description, and/or claims. As is well known in the art, the term“circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

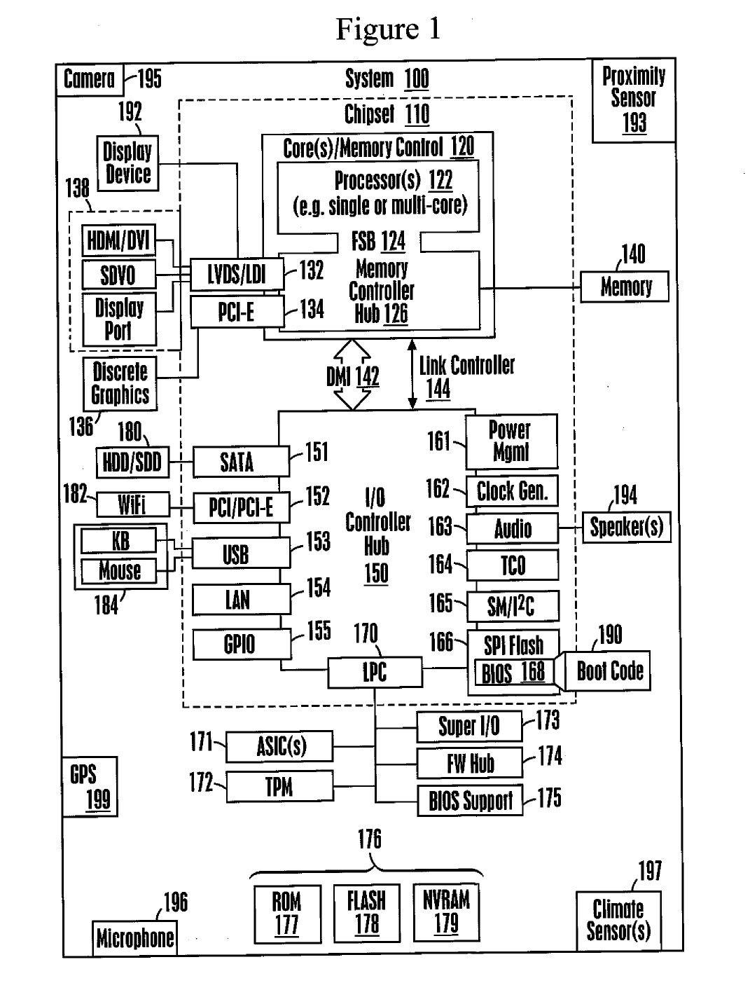

Now in reference to FIG. 1, it shows an exemplary block diagram of an exemplary computer system 100 such as e.g. an Internet enabled, computerized telephone (e.g. a smart phone), a tablet computer, a notebook or desktop computer, an Internet enabled computerized wearable device such as a smart watch, a computerized television (TV) such as a smart TV, so-called “convertible” devices such as e.g. a tablet that may be converted to a laptop by virtue of being connected to a soft keyboard, and/or other smart devices, etc. Thus, in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional“northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including e.g. one of more GPUs). An exemplary system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

In addition to the foregoing, the system 100 also may include sensors and/or a sensor array including e.g. a proximity, infrared, sonar, and/or heat sensor 193 providing input to the processor 122 and configured for sensing e.g. body heat of a person and/or the proximity of at least a portion of the person to at least a portion of the system 100 such as the sensor 193 itself. Also in some embodiments, the system 100 may include one or more cameras 195 providing input to the processor 122. The camera 195 may be, e.g., a thermal imaging camera, a digital camera such as a webcam, and/or a camera integrated into the system 100 and controllable by the processor 122 to gather pictures/images and/or video. Moreover, the system 100 may include an audio receiver/microphone (e.g. a microphone or microphone array) 196 for e.g. entering input such as a command to the system 100 in accordance with present principles.

In addition to the foregoing, the system 100 may include one or more climate sensors 197 (such as e.g., an (e.g. ambient) light sensor, a temperature sensor, a humidity sensor, and/or an environmental sensor) providing input to the processor 122. The system 100 may also include one or more motion sensors 198 (such as e.g., an accelerometer and/or a gesture sensor (e.g. for sensing gestures in free space associated by the device with commands in accordance with present principles), etc.) providing input to the processor 122. Though not shown, still other sensors may be included and their output used in accordance with present principles, such as e.g. biometric sensors, sound sensors, orientation sensors, location sensors, scan sensors, and/or time sensors. Also note that a GPS transceiver 199 is shown that is configured to e.g. receive geographic position information from at least one satellite and provide the information to the processor 122. However, it is to be understood that another suitable position receiver other than a GPS receiver may be used in accordance with present principles to e.g. determine the location of the system 100.

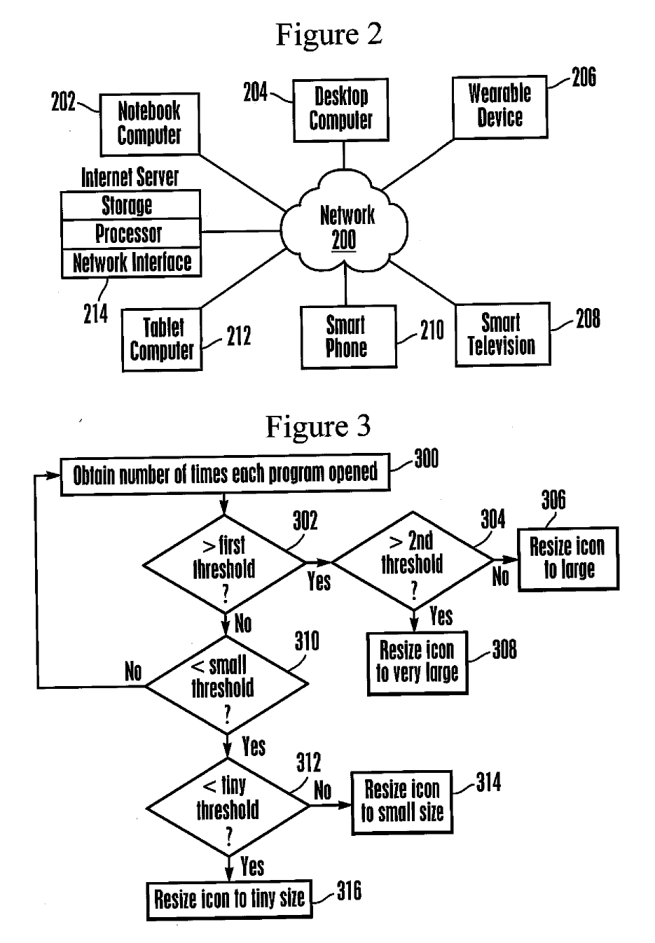

Before moving on to FIG. 2 and as described herein, it is to be understood that an exemplary device or other machine/computer may include fewer or more features than shown on the system 100 of FIG. 1. In any case, it is to be understood at least based on the foregoing that the system 100 is configured to undertake present principles.

Turning now to FIG. 2, it shows exemplary devices communicating over a network 200 such as e.g. the Internet in accordance with present principles is shown. It is to be understood that e.g. each of the devices described in reference to FIG. 2 may include at least some of the features, components, and/or elements of the system 100 described above. In any case, FIG. 2 shows a notebook computer 202, a desktop computer 204, a wearable device 206 such as e.g. a smart watch, a smart television (TV) 208, a smart phone 2120, a tablet computer 212, and a server 214 in accordance with present principles such as e.g. an Internet server that may e.g. provide cloud storage accessible to the devices 202-212. It is to be understood that the devices 202-214 are configured to communicate with each other over the network 200 to undertake present principles.

FIGS. 3-6 and 9 show example logic that may be executed by any of the processors/computers described above, and in a non-limiting example is executed by the smart phone 210. A “shortcut icon” in the discussion below refers to a user interface (UI) graphical element, sometimes also called a “tile” that can be selected by a user by means of, for instance, a point-and-click device and/or a touch screen to invoke or otherwise initiate a corresponding application on the device. Note that while flow chart format is used for convenience, the logic may be implemented as state logic. Note further that while icon size is varied in accordance with present principles based on importance of and/or a weight assigned to the corresponding application, in addition to or in lieu of changing icon size, the following may also be varied based on application importance and/or a weight in accordance with present principles, mutatis mutandis: icon color, icon border area (e.g. its total area), icon contrast (e.g. relative to other portions of the icon, and/or relative to a desktop and/or background image for the display), shading, opacity, and/or location (e.g. as presented on a display). For example, an “important” and/or higher weighted icon may be colored red from a default of green, given a bright contrast from a default normal contrast, and/or moved to the center of the display from a default location on the edges of the display. What's more, present principles recognize that in addition to or in lieu of the foregoing, e.g. magnitude of haptic feedback when touching the icon (e.g. the magnitude of vibrations emanating from a haptic element (e.g. vibrations) coupled to the display and/or another portion of the device such as e.g. the back panel opposite the display) may be varied based on application importance and/or a weight in accordance with present principles, mutatis mutandis, as may volume of audio (e.g. auditory feedback) from the device (e.g. when invoking the icon).

Commencing at block 300, an importance and/or weight of an application corresponding to a shortcut icon on, e.g., a desktop presentation on a display such as the display 192 with touchscreen capability is determined, in the logic shown in FIG. 3, by determining for each application how many times a user has opened it. For clarity below, importance and/or weight will be referred to simply as importance but is understood to additionally or alternatively include weight. In any case, note that the determination may be (and/or be based on) total cumulative openings of the application on the device or it may be made for a predetermined time period, e.g., the number of openings of an application in the past month. Thus, the predetermined time period may be a rolling time period.

Moving to decision diamond 302 it is determined whether the number obtained at block 300 satisfies a first threshold. If it does, the logic may if desired proceed to decision diamond 304 to determine whether the number satisfies a second threshold number larger than the first threshold. While two levels of importance are thus illustrated in FIG. 3, it is to be understood that only one level of importance need be used and tested for, and that more than two levels likewise may be used and tested for.

If the number obtained at block 300 does not satisfy the large (second) threshold but satisfies the first threshold, the logic flows from decision diamond 304 to block 306 to re-size the shortcut icon corresponding to the application under test to a large size, i.e., a size larger than a default icon size initially accorded to shortcut icons by the device. On the other hand, if the number obtained at block 300 satisfies the large (second) threshold, the logic flows from decision diamond 304 to block 308 to re-size the shortcut icon corresponding to the application under test to a very large size, i.e., a size larger than the large size otherwise accorded at block 306.

In some embodiments, shortcut icons of unused applications may be re-sized to be smaller than the default size, and in these embodiments the logic may flow from a negative test at decision diamond 302 to determine at decision diamond 310 whether the number obtained at block 300 satisfies a small threshold, for example, whether the number obtained at block 300 is at least as small as a first small threshold. A positive test may further cause the logic to move to decision diamond 312 whether the number obtained at block 300 satisfies a “tiny” threshold, for example, whether the number obtained at block 300 is at least as small as a second threshold smaller than the “small” threshold.

If the number obtained at block 300 does not satisfy the “tiny” threshold but satisfies the “small” threshold, the logic flows from decision diamond 312 to block 314 to re-size the shortcut icon corresponding to the application under test to a small size, i.e., a size smaller than the default icon size initially accorded to shortcut icons by the device. On the other hand, if the number obtained at block 300 satisfies the “tiny” threshold, the logic flows from decision diamond 312 to block 316 to re-size the shortcut icon corresponding to the application under test to a very small size, i.e., a size smaller than the small size otherwise accorded at block 314. The “tiny” size may be zero, i.e., the corresponding shortcut icon may be removed altogether from presentation at block 316. The negative test loop at decision diamond 310 simply indicates that each application accorded a shortcut icon may be so tested, periodically or upon triggering events if desired.

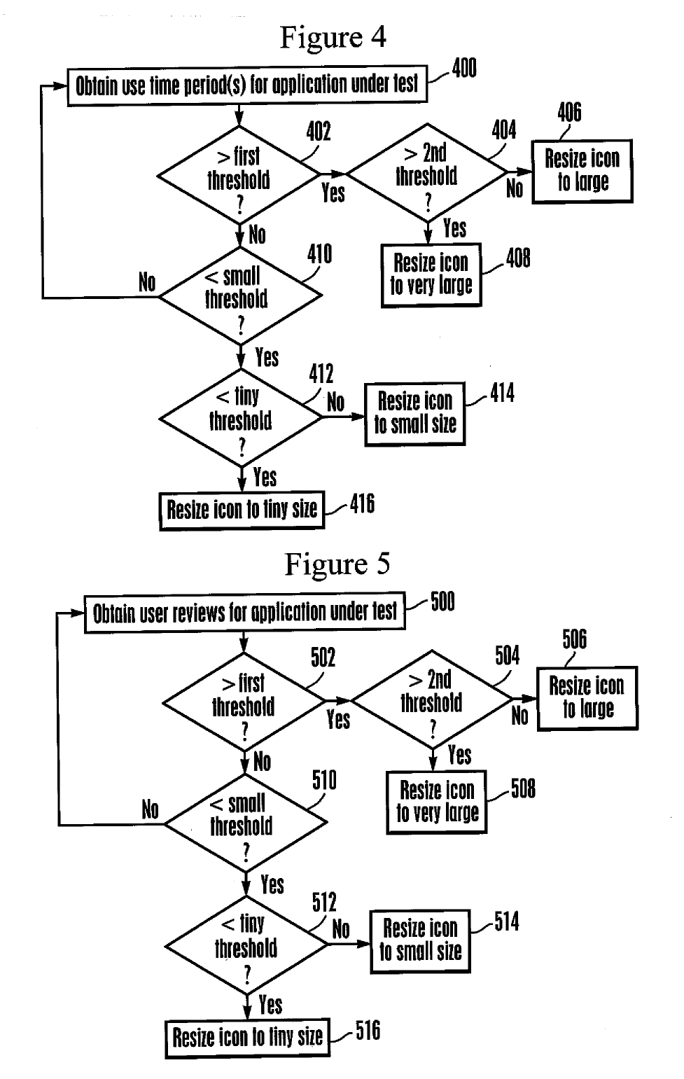

Turning to FIG. 4 and commencing at block 400, an importance of an application corresponding to a shortcut icon on, e.g., a desktop presentation on a display such as the display 192 with touchscreen capability is determined, in the logic shown in FIG. 4, by determining for each application how long a user has operated it, e.g., the length of the cumulative time periods between openings and closings of the application. Note that the determination may be total cumulative period of being open of the application on the device or it may be made for a predetermined time period, e.g., the length of time the application was open in the past month. Thus, the predetermined time period may be a rolling time period.

Moving to decision diamond 402 it is determined whether the number obtained at block 400 satisfies a first threshold. If it does, the logic may if desired proceed to decision diamond 404 to determine whether the number satisfies a second threshold number larger than the first threshold. While two levels of importance are thus illustrated in FIG. 4, it is to be understood that only one level of importance need be used and tested for, and that more than two levels likewise may be used and tested for.

If the number obtained at block 400 does not satisfy the large (second) threshold but satisfies the first threshold, the logic flows from decision diamond 404 to block 406 to re-size the shortcut icon corresponding to the application under test to a large size, i.e., a size larger than a default icon size initially accorded to shortcut icons by the device. On the other hand, if the number obtained at block 400 satisfies the large (second) threshold, the logic flows from decision diamond 404 to block 408 to re-size the shortcut icon corresponding to the application under test to a very large size, i.e., a size larger than the large size otherwise accorded at block 406.

In some embodiments, shortcut icons of unused applications may be re-sized to be smaller than the default size, and in these embodiments the logic may flow from a negative test at decision diamond 402 to determine at decision diamond 410 whether the number obtained at block 400 satisfies a small threshold, for example, whether the number obtained at block 400 is at least as small as a first small threshold. A positive test may further cause the logic to move to decision diamond 412 whether the number obtained at block 400 satisfies a “tiny” threshold, for example, whether the number obtained at block 400 is at least as small as a second threshold smaller than the “small” threshold.

If the number obtained at block 400 does not satisfy the “tiny” threshold but satisfies the “small” threshold, the logic flows from decision diamond 412 to block 414 to re-size the shortcut icon corresponding to the application under test to a small size, i.e., a size smaller than the default icon size initially accorded to shortcut icons by the device. On the other hand, if the number obtained at block 400 satisfies the “tiny” threshold, the logic flows from decision diamond 412 to block 416 to re-size the shortcut icon corresponding to the application under test to a very small size, i.e., a size smaller than the small size otherwise accorded at block 414. The “tiny” size may be zero, i.e., the corresponding shortcut icon may be removed altogether from presentation at block 416. The negative test loop at decision diamond 410 simply indicates that each application accorded a shortcut icon may be so tested, periodically or upon triggering events if desired.

Turning to FIG. 5 and commencing at block 500, an importance of an application corresponding to a shortcut icon on, e.g., a desktop presentation on a display such as the display 192 with touchscreen capability is determined, in the logic shown in FIG. 5, by determining for each application user reviews of the application (e.g. reviews from the Internet). A raw number of user reviews may be used and/or a quality accorded by the user to the application. This data is readily available as reviews typically are submitted online through the device, so that the device can track, using for example metadata in web pages submitted by the user, what application(s) are being reviewed and what the user-accorded quality evaluation is based on what blocks are filled in on the review forms. Note that the determination may be total cumulative reviews or reviews made for a predetermined time period, e.g., reviews of the application was open in the past month. Thus, the predetermined time period may be a rolling time period.

Moving to decision diamond 502 it is determined whether the number obtained at block 500 satisfies a first threshold. If it does, the logic may if desired proceed to decision diamond 504 to determine whether the number satisfies a second threshold number larger than the first threshold. While two levels of importance are thus illustrated in FIG. 5, it is to be understood that only one level of importance need be used and tested for, and that more than two levels likewise may be used and tested for.

If the number obtained at block 500 does not satisfy the large (second) threshold but satisfies the first threshold, the logic flows from decision diamond 504 to block 506 to re-size the shortcut icon corresponding to the application under test to a large size, i.e., a size larger than a default icon size initially accorded to shortcut icons by the device. On the other hand, if the number obtained at block 500 satisfies the large (second) threshold, the logic flows from decision diamond 504 to block 508 to re-size the shortcut icon corresponding to the application under test to a very large size, i.e., a size larger than the large size otherwise accorded at block 506.

In some embodiments, shortcut icons of unused applications may be re-sized to be smaller than the default size, and in these embodiments the logic may flow from a negative test at decision diamond 502 to determine at decision diamond 510 whether the number obtained at block 500 satisfies a small threshold, for example, whether the number obtained at block 500 is at least as small as a first small threshold. A positive test may further cause the logic to move to decision diamond 512 whether the number obtained at block 500 satisfies a “tiny” threshold, for example, whether the number obtained at block 500 is at least as small as a second threshold smaller than the “small” threshold.

If the number obtained at block 500 does not satisfy the “tiny” threshold but satisfies the “small” threshold, the logic flows from decision diamond 512 to block 514 to re-size the shortcut icon corresponding to the application under test to a small size, i.e., a size smaller than the default icon size initially accorded to shortcut icons by the device. On the other hand, if the number obtained at block 500 satisfies the “tiny” threshold, the logic flows from decision diamond 512 to block 516 to re-size the shortcut icon corresponding to the application under test to a very small size, i.e., a size smaller than the small size otherwise accorded at block 514. The “tiny” size may be zero, i.e., the corresponding shortcut icon may be removed altogether from presentation at block 516. The negative test loop at decision diamond 510 simply indicates that each application accorded a shortcut icon may be so tested, periodically or upon triggering events if desired.

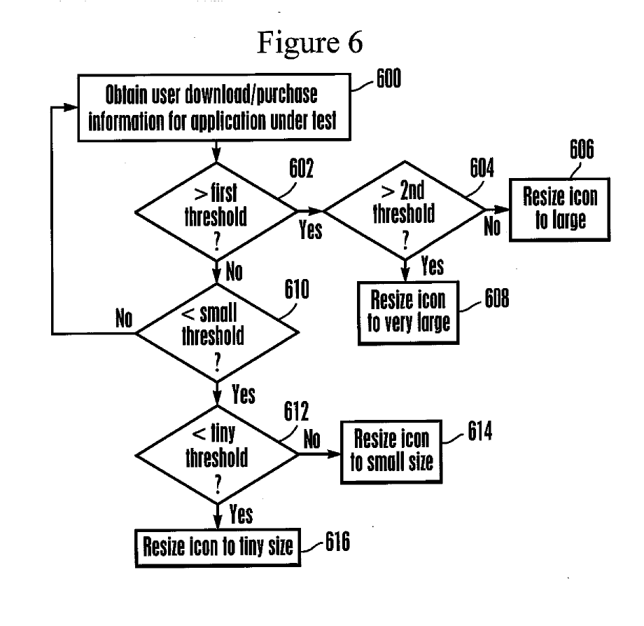

Turning to FIG. 6 and commencing at block 600, an importance of an application corresponding to a shortcut icon on, e.g., a desktop presentation on a display such as the display 192 with touchscreen capability is determined, in the logic shown in FIG. 6, by determining for each application user downloads and/or purchases made using or relating to the application. A raw number of downloads/purchases may be used. This data is readily available as the device can track, using for example metadata in web pages submitted by the user, what application(s) are being used to download or purchase items. Note that the determination may be total cumulative downloads/purchases or downloads/purchases made for a predetermined time period, e.g., downloads/purchases in the past month. Thus, the predetermined time period may be a rolling time period.

Moving to decision diamond 602 it is determined whether the number obtained at block 600 satisfies a first threshold. If it does, the logic may if desired proceed to decision diamond 604 to determine whether the number satisfies a second threshold number larger than the first threshold. While two levels of importance are thus illustrated in FIG. 6, it is to be understood that only one level of importance need be used and tested for, and that more than two levels likewise may be used and tested for.

If the number obtained at block 600 does not satisfy the large (second) threshold but satisfies the first threshold, the logic flows from decision diamond 604 to block 606 to re-size the shortcut icon corresponding to the application under test to a large size, i.e., a size larger than a default icon size initially accorded to shortcut icons by the device. On the other hand, if the number obtained at block 600 satisfies the large (second) threshold, the logic flows from decision diamond 604 to block 608 to re-size the shortcut icon corresponding to the application under test to a very large size, i.e., a size larger than the large size otherwise accorded at block 606.

In some embodiments, shortcut icons of unused applications may be re-sized to be smaller than the default size, and in these embodiments the logic may flow from a negative test at decision diamond 602 to determine at decision diamond 610 whether the number obtained at block 600 satisfies a small threshold, for example, whether the number obtained at block 600 is at least as small as a first small threshold. A positive test may further cause the logic to move to decision diamond 612 whether the number obtained at block 600 satisfies a “tiny” threshold, for example, whether the number obtained at block 600 is at least as small as a second threshold smaller than the “small” threshold.

If the number obtained at block 600 does not satisfy the “tiny” threshold but satisfies the “small” threshold, the logic flows from decision diamond 612 to block 614 to re-size the shortcut icon corresponding to the application under test to a small size, i.e., a size smaller than the default icon size initially accorded to shortcut icons by the device. On the other hand, if the number obtained at block 600 satisfies the “tiny” threshold, the logic flows from decision diamond 612 to block 616 to re-size the shortcut icon corresponding to the application under test to a very small size, i.e., a size smaller than the small size otherwise accorded at block 614. The “tiny” size may be zero, i.e., the corresponding shortcut icon may be removed altogether from presentation at block 616. The negative test loop at decision diamond 610 simply indicates that each application accorded a shortcut icon may be so tested, periodically or upon triggering events if desired.

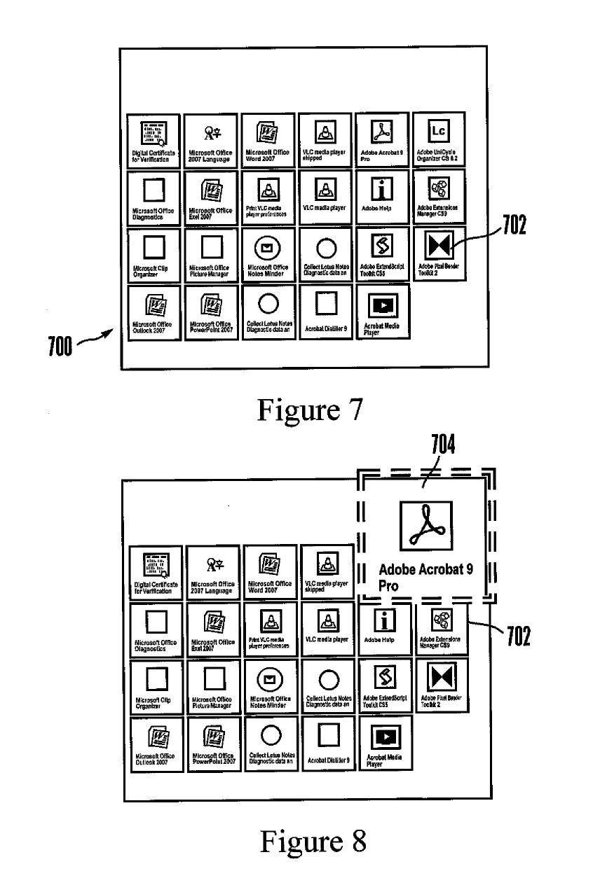

FIGS. 7 and 8 illustrate the above principles. A portion 700 of a desktop application shortcut icon display is shown in which each of the icons 702 initially are accorded the same default size (color/contrast/position in the icon grid). However, as shown in FIG. 8 the application corresponding to the icon 704 has been determined to be “important”, resulting in the icon 704 assuming a larger size than the other icons and in the embodiment shown in a position that overlays other icons in the top right corner, potentially also or alternatively with a brighter contract and/or color than the other icons around, e.g., the icons borders.

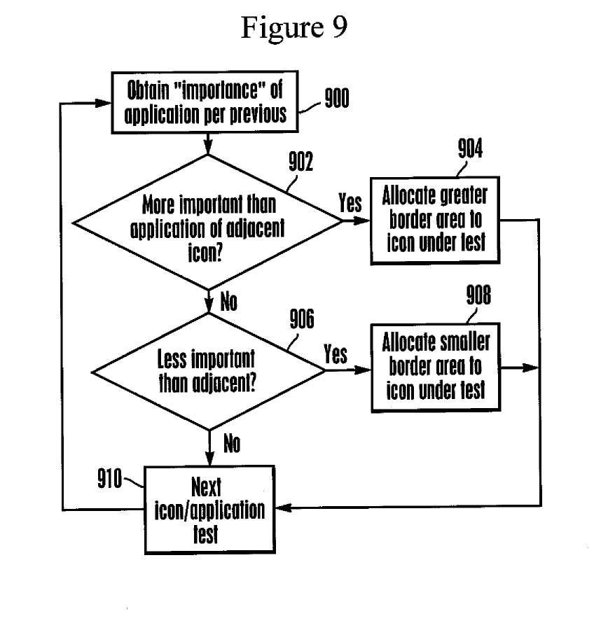

FIG. 9 shows an alternate way to account for application importance by allocating greater inter-icon border areas as areas that if touched are interpreted to mean a selection of a nearby icon. For at least some applications, their importances are determined at block 900 using principles described previously. The importance of each pair of adjacent icons which share an inter-icon border region between them (“icon pair”) is evaluated at decision diamond 902. If the application corresponding to one icon in the pair is determined to be more important than the application corresponding to the other icon in the pair, a greater portion of the border area between the two icons is allocated to the icon of the more important application at block 904. On the flip side of the coin, a determination at decision diamond 906 that the application corresponding to one icon in the pair is determined to be less important than the application corresponding to the other icon in the pair results in a smaller portion of the border area between the two icons being allocated to the icon of the less important application at block 908, and this process may be repeated as indicated at block 910 for each application having a shortcut icon.

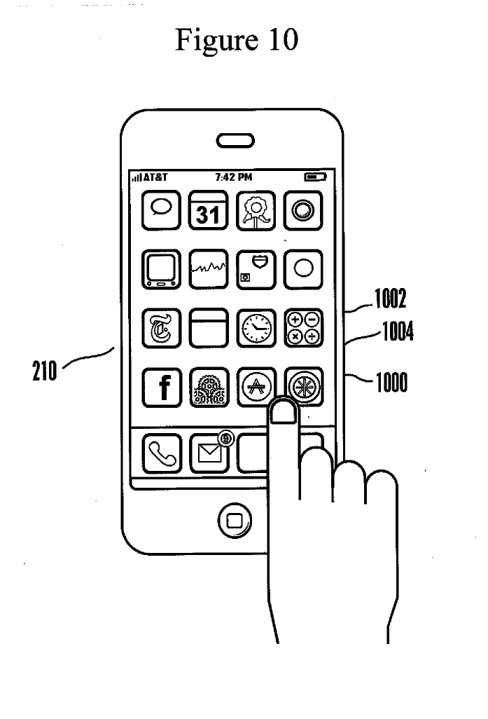

FIG. 10 shows the example smart phone 210 display presenting multiple icons or tiles, two of which (e.g. icons 1000 and 1002) are adjacent from each other and are separated from each other by a border region at which the illustrated index finger is pointed. Thus, the border region lies outside the perimeter of each adjacent tile.

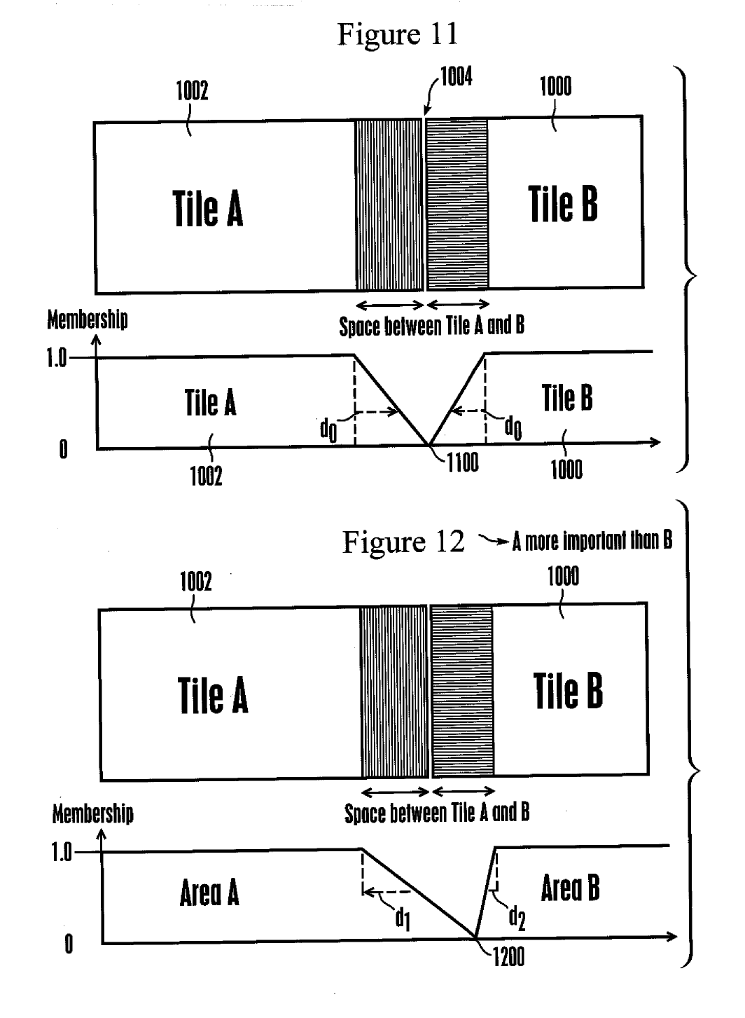

FIGS. 11 and 12 illustrate the above. In each figure, the top portion schematically shows portions of the tiles as they would appear looking down on the display while the bottom portion schematically shows touch regions corresponding to the physical regions in the top portion. Please note that while FIGS. 11 and 12 appear to show icons (labeled “tiles” in FIGS. 11 and 12) of different sizes, and that while different sizes may also be used to delineate importance, it is contemplated that the sizes of tiles in some examples of FIGS. 9-12 do not change and remain one single default size.

In FIG. 11, by default it is assumed that the applications corresponding to tiles 1000 and 1002 are equally important, so that the border region 1004 between the tiles is allocated equally between the tiles. Thus for example, a touch anywhere in the border region 1004 may result in a determination that neither tile was meant to be selected. Or, a touch anywhere in one of the halves of the border region is interpreted to be a touch on the tile nearest that half. Yet again, a touch in the quarter of the region 1004 nearest a tile is considered to be a touch on the nearest tile with a touch in the half of the border region lying between the end quarter regions being interpreted not to be a touch on any tile. In FIG. 11, the respective quarter regions nearest the regions 1000, 1002 have equal widths denoted D0 in FIG. 11. In any case, whatever default allocation border region touch allocation scheme is in place, both tiles are treated equally, as indicated by the border region demarcation line 1100 being midway between the adjacent tile perimeters.

In contrast, FIG. 12 tile A (1002) has been determined to be more important than tile B (1000). Here, the border region demarcation line 1200 has been moved to be much closer to the less important tile B (1000), meaning more of the border region has been allocated as a touch region for selecting the application corresponding to the more important tile A (1002). A touch anywhere between the tile A (1002) and the border region demarcation line 1200 may be interpreted to be a touch on the tile A, whereas touches in the smaller area between the border region demarcation line 1200 and the tile B may be considered to be a touch on the tile B. Or, using one of the above-described examples, a touch in the region portion defined by the halfway point on the line sloping from the more important tile A to the border region demarcation line 1200 (distance D1 from the perimeter of the important tile A) may be allocated as a touch region of the important tile A, while a touch in the region portion defined by the halfway point on the line sloping from the less important tile B to the border region demarcation line 1200 (distance D2 from the perimeter of the less important tile B, D2<D1) may be allocated as a touch region of the less important tile B.

Without reference to any particular figure, it is to be understood that present principles apply not only to “icons” on the traditional desktop sense, but any element presentable on a display of a system such as the system 100, such as e.g. tiles in a touch-screen environment and/or mobile environment, and still other selector elements presentable on the devices disclosed herein.

Still without reference to any particular figure, present principles recognize that although e.g. a software application for undertaking present principles may be vended with a device such as the system 100, it is to be understood that present principles apply in instances where such an application is e.g. downloaded from a server to a device over a network such as the Internet.

Further still without reference to any particular figure, it is to be understood that visual statuses for icons (e.g. based on usage, frequency of selection, etc.) in accordance with present principles may be based on appearance variations that include more than variations in sizing of respective icons. As an example, the location of the tile may be varied (e.g. a more frequently selected and/or more weighted tile being more centrally located and/or presented on a display (e.g. both vertically and horizontally) than a relatively less frequently selected and/or weighted tile). As another example, a front row tile may be more weighted. As yet another example, the coloring and/or shading of various tiles may vary based on e.g. importance and/or weight (e.g., a relatively less important and/or weighted tile is shaded with less details than a relatively more important and/or weighted tile).

While the particular CHANGING USER INTERFACE ELEMENT BASED ON INTERACTION THEREWITH is herein shown and described in detail, it is to be understood that the subject matter which is encompassed by the present application is limited only by the claims.

What is claimed is:

1. An apparatus, comprising:
a processor;
a memory accessible to the processor and bearing instructions executable by the processor to:
determine a weight for an application based on user interaction therewith; and
establish how much of an area between a shortcut icon and a second icon is allocated to the application based at least in part on the weight, wherein the shortcut icon is selectable to invoke the application.

2. The apparatus of claim 1, wherein the weight includes a number of times the application has been opened on the apparatus.

3. The apparatus of claim 1, wherein the weight includes a number of times the application has been opened within a test period on the apparatus.

4. The apparatus of claim 1, wherein the weight includes a length of time the application has been used on the apparatus.

5. The apparatus of claim 1, wherein the weight includes user reviews of the application.

6. An apparatus, comprising:
a processor;
a memory accessible to the processor and bearing instructions executable by the processor to:
determine a weight of an application based on user interaction therewith; and
alter a parameter related to a shortcut icon selectable to invoke the application based at least in part on the weight.

7. The apparatus of claim 6, wherein the parameter comprises how much of an area between a shortcut icon selectable to invoke the application and a second icon is allocated to the application based at least in part on the weight.

8. The apparatus of claim 6, wherein the alteration of the parameter affects a visual status of a shortcut icon selectable to invoke the application.

9. The apparatus of claim 8, wherein the visual status is altered based on a parameter selected from the group consisting of size, shape, opacity, and brightness.

10. The apparatus of claim 6, wherein the parameter is selected from the group consisting of an audible parameter and a haptic parameter.

11. The apparatus of claim 6, wherein the weight includes a number of times the application has been opened on the apparatus.

12. The apparatus of claim 6, wherein the weight includes a number of times the application has been opened within a test period on the apparatus.

13. The apparatus of claim 6, wherein the weight includes a length of time the application has been used on the apparatus.

14. The apparatus of claim 6, wherein the weight includes a length of time the application has been used on the apparatus within a test period.

15. The apparatus of claim 6, wherein the weight is correlated to user reviews of the application.

16. The apparatus of claim 6, wherein the weight includes transactions made related to the application.

17. A method, comprising:
determining a weight of an application based on user interaction therewith; and
altering a parameter related to a shortcut icon selectable to invoke the application based at least in part on the weight.

18. The method of claim 17, wherein the parameter comprises how much of an area between a shortcut icon selectable to invoke the application and a second icon is allocated to the application based at least in part on the weight.

19. The method of claim 17, wherein the altering of the parameter affects a visual status of a shortcut icon selectable to invoke the application.

20. The method of claim 19, wherein the visual status is altered based on a parameter selected from the group consisting of size, shape, opacity, and brightness.

21. The method of claim 17, wherein the parameter is selected from the group consisting of an audible parameter and a haptic parameter.

22. The method of claim 17, wherein the parameter comprises a size of a shortcut icon selectable to invoke the application, and wherein the weight is determined based on at least one of reviews of the application, transactions made related to the application.

23. The method of claim 17, wherein the weight is based at least in part on a number of times the application has been opened.

24. The method of claim 17, wherein the weight is based at least in part on a length of time the application has been used.
